(19) United States
(12) Patent Application Publication
(10) Pub. No.: US 2010/0014043 A1
(43) Pub. Date: Jan. 21, 2010

(54) LIQUID CRYSTAL DISPLAY ELEMENT

(76) Inventors: Hiroshi Ootaguro, Ishikawa (JP); Yoshio Iwai, Ishikawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/519,081

(22) PCT Filed: Nov. 27, 2007
(86) PCT No.: PCT/JP2007/072805

§ 371 Date: Jun. 12, 2009

(30) Foreign Application Priority Data
Dec. 14, 2006 (JP) 2006-336910

(51) Int. Cl. G02F 1/1339

(52) U.S. Cl. 349/154

(57) ABSTRACT

A protruding portion 29 composed of protruding portions 29a, 29b is provided, with the same material as that of color filter layers 21R, 21G, 21B and a black matrix layer 22 different from a seal material for adhesively attaching an array substrate and a counter substrate 12 to each other, on a principal surface of the counter substrate 12. A liquid crystal filling port for filling a liquid crystal material LC to compose a liquid crystal layer 13 between the substrates 11 and 12 is sectioned by the protruding portions 29a, 29b. The shape and dimensions of the liquid crystal filling port can be stabilized to improve manufacturability.

### TECHNICAL FIELD

The present invention relates to a liquid crystal display element provided with a liquid crystal filling port for filling a liquid crystal material between substrates.

### BACKGROUND ART

Conventionally, a liquid crystal cell being this type of liquid crystal display element has been constructed with a pair of substrates, a liquid crystal layer made of a liquid crystal material being interposed between these substrates, and peripheral edge portions of the pair of substrates being adhesively attached to each other by a seal material being an adhesive such as, for example, an ultraviolet curing resin.

Such liquid crystal cells are manufactured by, for example, cutting a board device, for which a pair of large-sized substrates are adhesively attached at predetermined positions to each other by a seal material, at their respective predetermined positions, filling a liquid crystal material between the substrates from liquid crystal filling ports sectioned by the seal material, and then blocking the liquid crystal filling ports.

Here, when forming the liquid crystal filling ports, the seal material is extended from the inside of each liquid crystal cell to the outside of the liquid crystal cell intersecting with the cutting position in the large-sized substrates, and thereby causing the liquid crystal filling ports appear at end portions of the liquid crystal cells when the substrates are cut (see Patent Document 1, for example.).
Patent Document 1: Japanese Laid-Open Patent Publication No. 2000-66165.

### DISCLOSURE OF THE INVENTION

### Problems to be Solved by the Invention

However, the liquid crystal cells described above have had a problem that because the liquid crystal filling ports are formed of a seal material, if the seal width varies, the width of the liquid crystal filling ports also varies, and variation in filling time of the liquid crystal material and sealing time occurs, so that quality variation may occur.

Moreover, because a part of the pair of large-sized substrates adhesively attached to each other by the seal material extended to the outside of the liquid crystal cell can be cracked at the time of cutting, a buffer region must be provided between the liquid crystal cells mutually adjacent on the pair of large-sized substrates so as to prevent influence of pattern peeling and the like due to the cracking mentioned above, and there is also a problem that the distance between the liquid crystal cells cannot be shortened, and thus the number of cells that can be yielded is reduced.

Consequently, the conventional liquid crystal cells have had a problem that manufacturability is not satisfactory.

The present invention has been made in view of such problems, and an object thereof is to provide a liquid crystal display element improved in manufacturability.

### Means to Solve The Problems

The present invention provides a liquid crystal display element including: a pair of substrates adhesively attached to each other by an adhesive; a liquid crystal layer made of a liquid crystal material and interposed between the pair of substrates; and a protruding portion provided with a material different from the adhesive on a principal surface of either one of the pair of substrates, for sectioning a liquid crystal filling port for filling the liquid crystal material between the pair of substrates.

Moreover, the present invention provides a liquid crystal display element including: a pair of substrates adhesively attached to each other by an adhesive; a liquid crystal layer made of a liquid crystal material and interposed between the pair of substrates; and a protruding portion provided with a material different from the adhesive on a principal surface of either one of the pair of substrates, for sectioning a liquid crystal filling port for filling the liquid crystal material between the pair of substrates, wherein the one of the substrates includes a projecting part projected outward further than the other substrate, and the protruding portion includes an adhesive blocking layer for blocking the adhesive from flowing into the projecting part, and is formed of a material containing no adhesive component.

Furthermore, the present invention provides a liquid crystal display element including: a pair of substrates adhesively attached to each other by an adhesive; a liquid crystal layer made of a liquid crystal material and interposed between the pair of substrates; and a protruding portion provided with a material different from the adhesive on a principal surface of either one of the pair of substrates, for sectioning a liquid crystal filling port for filling the liquid crystal material between the pair of substrates, wherein the one of the substrates includes a projecting part projected outward further than the other substrate, and the protruding portion includes an adhesive blocking layer for blocking the adhesive from flowing into the projecting part, and is formed of a material containing no adhesive component being overlapped with a part of the adhesive.

Then, by the protruding portion provided with a material different from the adhesive for adhesively attaching the pair of substrates to each other, the liquid crystal filling port for filling the liquid crystal material to compose the liquid crystal layer between the pair of substrates is sectioned.

### EFFECTS OF THE INVENTION

According to the present invention, the shape and dimensions of the liquid crystal filling port can be stabilized to improve manufacturability.

### BRIEF DESCRIPTION of THE DRAWINGS

FIG. 1 is a longitudinal sectional view showing a liquid crystal display element of a first embodiment of the present invention.

FIG. 2 is a plan view showing the same liquid crystal display element as the above.

FIG. 3 is a plan view showing a board device from which the same liquid crystal display element as the above is cut.

FIG. 4 is a longitudinal sectional view showing the main part of a liquid crystal display element of a second embodiment of the present invention.

FIG. 5 is a longitudinal sectional view showing the main part of a liquid crystal display element of a third embodiment of the present invention.

FIG. 6 is a longitudinal sectional view showing the main part of a liquid crystal display element of a fourth embodiment of the present invention.

### REFERENCE NUMERALS

4 Seal material serving as adhesive

5 Liquid crystal cell serving as liquid crystal display element

11 Array substrate serving as substrate

12 Counter substrate serving as substrate

13 Liquid crystal layer

24 Circuit portion serving as projecting part

27 Liquid crystal filling port

29 Protruding portion

37 Third layer serving as adhesive blocking layer

38 Fourth layer serving as adhesive blocking layer

47 First layer serving as adhesive blocking layer

48 Fourth layer serving as adhesive blocking layer

LC Liquid crystal material

### BEST MODE FOR CARRYING OUT THE INVENTION

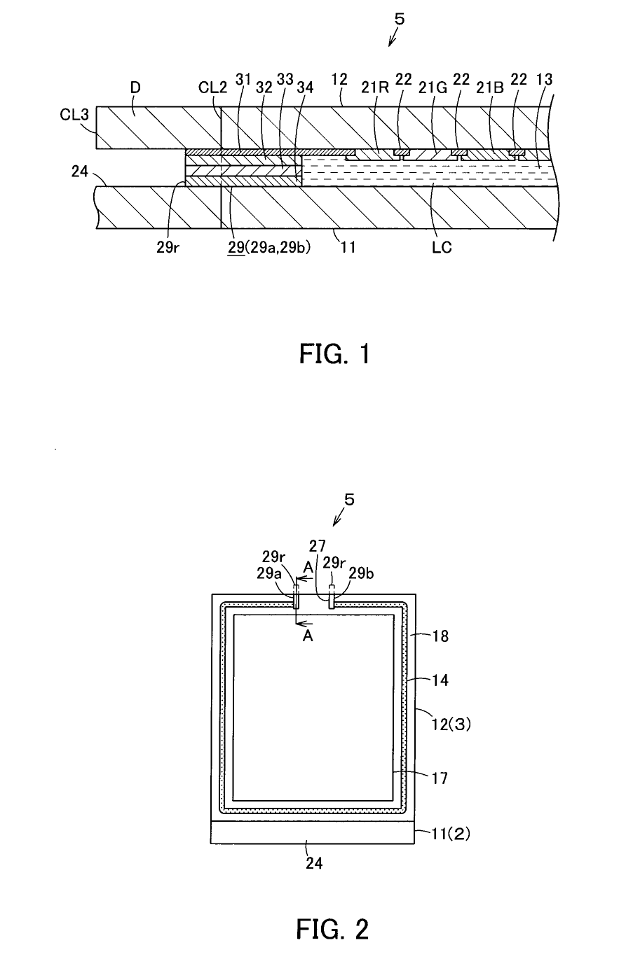

Hereinafter, a construction of a liquid crystal display element of a first embodiment of the present invention will be described with reference to FIG. 1 to FIG. 3.

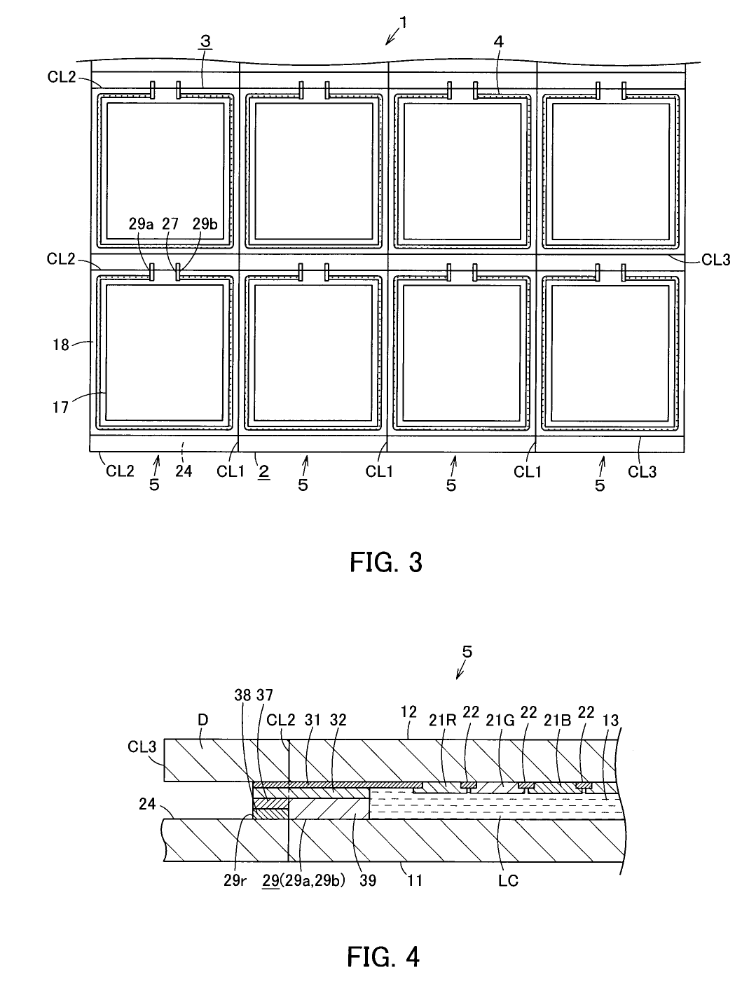

In FIG. 3, reference numeral 1 denotes a board device, the board device 1 is constructed by arranging a first large-sized substrate 2 being a glass substrate serving as a large-sized substrate and a second large-sized substrate 3 being a glass substrate serving as a large-sized substrate so as to oppose each other and adhesively attaching these at predetermined positions to each other by a seal material 4 serving as an adhesive being a light curing resin such as, for example, an ultraviolet curing resin, there formed are a plurality of liquid crystal cells 5 serving as liquid crystal display elements in a matrix form without intervals therebetween, and from which these liquid crystal cells 5 can be cut.

Here, each liquid crystal cell 5 is of an active matrix type, and includes, as shown in FIG. 1 and FIG. 2, an array substrate 11 serving as a substrate to be cut out of the first large-sized substrate 2, a counter substrate 12 serving as a substrate to be cut out of the second large-sized substrate 3, and a liquid crystal layer 13 interposed between the array substrate 11 and the counter substrate 12, and in a manner enclosing the liquid crystal layer 13, the array substrate 11 (first large-sized substrate 2) and the counter substrate 12 (second large-sized substrate 3) are adhesively attached to each other by an adhesive layer 14 formed of the seal material 4. In addition, on the liquid crystal cells 5, formed are display regions 17 where pixels (not shown) are arranged in matrix forms to display images and non-display regions 18 located outside the display regions 17. Here, FIG. 1 is a longitudinal sectional view showing an A-A section of FIG. 2.

On one principal surface of the array substrate 11, although not shown, in a position corresponding to the display region 17, a plurality of signal lines and a plurality of scanning lines are deposited from a metal in a grid pattern, and at intersections between the signal lines and scanning lines, thin-film transistors (TFTs) serving as switching elements for driving the respective pixels are arranged. Moreover, in the position corresponding to the display region 17 of the array substrate 11, various insulating films (not shown) are formed of insulators, pixel electrodes (not shown) of the pixels are formed of a metal or the like, and an alignment film, spacers for holding a gap between the array substrate 11 and the counter substrate 12, etc., are formed of a resin or the like. Accordingly, a plurality of types of films are formed on the array substrate 11.

For the counter substrate 12, laminated on one principal surface at the side opposing the array substrate 11 are color filter layers 21R, 21G, 21B serving as colored layers, a counter electrode, an alignment film (not shown), etc. Moreover, between the color filter layers 21R, 21G, 21B and in the non-display region 18, formed is a black matrix (BM) layer 22 being a resin black layer serving as a light shielding film formed of a black resin. Therefore, a plurality of types of films are formed on the counter substrate 12.

The color filter layers 21R, 21G, 21B, which correspond to red (R), green (G), and blue (B), respectively, are formed of, for example, an ultraviolet curing acrylic resin resist or the like serving as a colored resin for dispersing a pigment of each color and transmitting light of each color component, and are formed for each of the pixels, respectively.

Moreover, the counter substrate 12 is formed smaller than the array substrate 11 in a plan view. Therefore, there provided at a position where the counter substrate 12 is not facing the array substrate 11 is a circuit portion 24 serving as a projecting part including a driver IC (not shown) and the like serving as a driving unit electrically connected to the thin-film transistors etc., via the signal lines and scanning lines.

In addition, the respective liquid crystal cells 5, which are formed on the board device 1 so that the display region 17 of one liquid crystal cell 5 is in sequence adjacent to the circuit portions 24 of the other liquid crystal cells 5 adjacent in a predetermined direction, for example, the upper and lower direction shown in FIG. 3, are divided from the board device 1 at the position of cut lines by a board cutting machine (not shown).

Here, the cut lines include a cut line CL1 formed on the first large-sized substrate 2 and the second large-sized substrate 3 along a boundary of the liquid crystal cells 5, 5 adjacent in the left and right direction shown in FIG. 3, a cut line CL2 formed on the first large-sized substrate 2 and the second large-sized substrate 3 along a boundary of the liquid crystal cells 5, 5 adjacent in the upper and lower direction shown in FIG. 3, and a cut line CL3 formed on the second large-sized substrate 3 so as to expose the circuit portions 24.

In addition, each of the cut lines CL1, CL2 serves as outer edges of each liquid crystal cell 5, and the second large-sized substrate 3 between the cut line CL2 and the cut line CL3 adjacent there to at a slight distance serves as a cutting margin D when the liquid crystal cells 5 are cut out.

In addition, the liquid crystal layer 13 is formed by filling a liquid crystal material LC from a liquid crystal filling port 27 formed on each liquid crystal cell 5 cut out of the large-sized substrates 2, 3 between the array substrate 11 and the counter substrate 12.

Here, the liquid crystal filling port 27 is, at almost a center area in the left and right direction of FIG. 2 of the liquid crystal cell 5 and at an end portion on the side opposite to the circuit portion 24, formed in a sectioned manner between protruding portions 29a, 29b of a protruding portion 29 that is continuous with the adhesive layer 14.

The protruding portions 29a, 29b are provided apart from each other in the left and right direction of the figure so as to continue, from the non-display region 18 of the liquid crystal cell 5, to the circuit portion 24 of the liquid crystal cell 5 adjacent at the upper side of FIG. 3 intersecting with the cut line CL2 shown in FIG. 3 from the end portion of the liquid crystal cell 5. Accordingly, parts of the protruding portions 29a, 29b located outside the cut line CL2, that is, on the circuit portion 24 of the adjacent liquid crystal cell 5, serve as removing portions 29r to be removed, when the cutting margin D is cut away from the counter substrate 12 (second large-sized substrate 3), along with the cutting margin D.

Moreover, the protruding portions 29a, 29b are formed, on the counter board 12 side, by laminating in sequence a first layer 31 formed of the same material as that of the black matrix layer 22 and in the same process as that for the black matrix layer 22 and a second layer 32, a third layer 33, and a fourth layer 34 formed of the same materials as those of the color filter layers 21R, 21G, 21B, respectively, and in the same processes as those for the color filter layers 21R, 21G, 21B, respectively. More specifically, the protruding portions 29a, 29b are formed of materials interposed between the substrates 11 and 12 and containing no adhesive component. Here, the thickness of each of the layers 31 to 34 is appropriately set according to the gap between the array substrate 11 and the counter substrate 12. In the present embodiment, the gap between the array substrate 11 and the counter substrate 12 is approximately 5.0 μm, and thus when formed of resins as in the above, each of the layers 31 to 34 is provided at a thickness of, for example, approximately 1.25 μm.

The adhesive layer 14 is formed so as to enclose the display region 17 with the non-display region 18, and continues up to the outside of the protruding portions 29a, 29b.

Next, a manufacturing method of the liquid crystal display element of the first embodiment will be described.

At a predetermined position of the first large-sized substrate 2, appropriately formed of metals, insulators, resins, etc., are scanning lines, signal lines, thin-film transistors, insulating films, pixel electrodes, an alignment film, spacers, etc., by, for example, photolithography, pattern printing, etc. (a first large-sized substrate forming step).

Moreover, at a predetermined position of the second large-sized substrate 3, appropriately formed of metals, resins, etc., are a black matrix layer 22, color filter layers 21R, 21G, 21B, a counter electrode and an alignment film (not shown), etc., and simultaneously with the black matrix layer 22 and the color filter layers 21R, 21G, 21B, formed by the first layer 31 to the fourth layer 34 of the same materials as those of the black matrix layer 22 and the color filter layers 21R, 21G, 21B are the protruding portions 29a, 29b by, for example, photolithography, pattern printing, etc. (a second large-sized substrate forming step).

Then, the seal material 4 is applied at a predetermined position, of the first large-sized substrate 2, corresponding to each liquid crystal cell 5 to adhesively attach the first large-sized substrate 2 and the second large-sized substrate 3 to each other while aligning with each other, these large-sized substrates 2 and 3 are irradiated with light such as ultraviolet rays via a mask or the like (not shown) to solidify the seal material 4 to thereby fix the first large-sized substrate 2 and the second large-sized substrate 3 to each other.

Furthermore, the liquid crystal cells 5 are respectively cut out along the cut lines CL1, CL2, and the cutting margin D at the counter substrate 12 side located on the circuit portion 24 is removed along the cut line CL3.

At this time, as a result of the cut line CL2 crossing the protruding portions 29a, 29b, the tip portion of each of these protruding portions 29a, 29b is removed as a removing portion 29r along with the cutting margin D, and the liquid crystal filling port 27 is formed between the protruding portions 29a, 29b.

Then, by filling a predetermined amount (predetermined time) of liquid crystal material LC from the liquid crystal filling port 27, a liquid crystal layer 13 is formed between the array substrate 11 and the counter substrate 24.

Thereafter, the liquid crystal filling port 27 is blocked by a light curing resin such as an ultraviolet curing resin (not shown) to complete the liquid crystal cell 5.

As described above, in the above-mentioned first embodiment, the liquid crystal filling port 27 for filling the liquid crystal material LC to compose the liquid crystal layer 13 between the substrates 11 and 12 is sectioned by the protruding portions 29a, 29b formed of materials different from the seal material 4 to adhesively attach the substrates 11 and 12, for example, the same materials as those of the color filter layers 21R, 21G, 21B and the black matrix layer 22 provided on the substrate 12.

Therefore, as compared to the conventional case where the protruding portions are formed of a seal material, the protruding portions 29a, 29b never flow before hardening the seal material, the protruding portions 29a, 29b are improved in accuracy, the shape and dimensions of the liquid crystal filling port 27 can be stabilized, variation in the filling time of the liquid crystal material LC to be filled from the liquid crystal filling port 27, the sealing time of the liquid crystal filling port 27 after filling the liquid crystal material LC, etc., can be reduced, so that quality of the liquid crystal cell 5 can be stabilized.

Moreover, because the protruding portions 29a, 29b are formed of the materials containing no adhesive component, the protruding portions 29a, 29b are not adhered to the array substrate 11, and thus if the cutting margin D is cut away along the cut line CL3 when cutting out the liquid crystal cell 5 from the board device 1, the tip portions of the protruding portions 29a, 29b projected into the circuit portion 24 of the adjacent liquid crystal cell 5 are removed as the removing portions 29r along with the cutting margin D, and therefore, it is not necessary to form a buffer region, which is a margin to prevent pattern peeling and the like resulting from cracking of the circuit portion due to the adhered protruding portions between the liquid crystal cells 5 and 5, the built-in number of the crystal cells 5 in the board device 1 can be increased, and production efficiency can be improved.

As a result, manufacturability of the liquid crystal cells 5 can be improved.

Moreover, because the protruding portions 29a, 29b are formed of identical materials to those of the color filter layers 21R, 21G, 22B and the black matrix layer 22 formed on the counter substrate 12 being materials interposed between the substrates and 12 and thus can be formed in the same processes as those for the color filter layers 21R, 21G, 22B and the black matrix layer 22, there is no such case where an extra process for forming the protruding portions 29a, 29b is added to lower manufacturability.

Furthermore, as a result of forming the protruding portions 29a, 29b by resin layers, the thickness of the layers to 34 can be secured, respectively, so that the protruding portion 29 can be easily formed.

Next, a second embodiment will be described with reference to FIG. 4. Also, the same constructions and operations as those of the above-mentioned first embodiment will be denoted with identical reference numerals, and descriptions thereof will be omitted.

For the second embodiment, in the above-mentioned first embodiment, formed in place of the third layer 33 and the fourth layer 34 of the protruding portions 29a, 29b are a third layer 37 serving as an adhesive blocking layer, a fourth layer 38 serving as an adhesive blocking layer, and an adhesive layer to be dammed up by the third layer 37 and the fourth layer and blocked from flowing into the circuit portion 24 side of the adjacent liquid crystal cell 5.

The third layer 37, which is formed of the same material as that of, for example, the color filter layer 21G and in the same process as that therefor, is formed, corresponding to the position of the cut line CL2, on the circuit portion 24 of the adjacent liquid crystal cell 5 located outside the cut line CL2.

Likewise, the fourth layer 38, which is formed of the same material as that of, for example, the color filter layer 21B and in the same process as that therefor, is formed, corresponding to the position of the cut line CL2 and the third layer 37, on the circuit portion 24 of the adjacent liquid crystal cell 5 located outside the cut line CL2.

In addition, the adhesion layer 39 is continuous with the adhesion layer 14, and is formed, as a result of the seal material 4 being dammed up by the third layer 37 and the fourth layer 38, at a position inside the cut line CL2 so as to be overlapped with, for example, the first layer 31 and the second layer 32.

Here, because the seal material 4 sometimes contains a filler (not shown) having a particle diameter of, for example, approximately 2.0 μm, the thickness of the adhesion layer 39 is set corresponding to the particle diameter of the filler.

In addition, as a result of having the same construction as that of the above-mentioned first embodiment, such as sectioning the liquid crystal filling port 27 by the protruding portions 29a, 29b formed of materials different from the seal material 4, the second embodiment can provide the same operations and effects as those of the above-mentioned first embodiment.

Moreover, using a part of the seal material 4 for formation of the protruding portions 29a, 29b allows constructing more simply without decreasing accuracy.

Furthermore, as a result of providing the third layer 37 and the fourth layer 38, the seal material 4 can be prevented from flowing into the adjacent liquid crystal cell 5, so that the tip portions of the protruding portions 29a, 29b are not adhered to the circuit portion 24, and the tip portions of the protruding portions 29a, 29b are removed as the removing portions 29r along with the cutting margin D when cutting away the cutting margin D, and thus this allows reliably preventing, when cutting away the cutting margin D, occurrence of cracking and the like in the circuit portion 24 and the like of the adjacent liquid crystal cell 5.

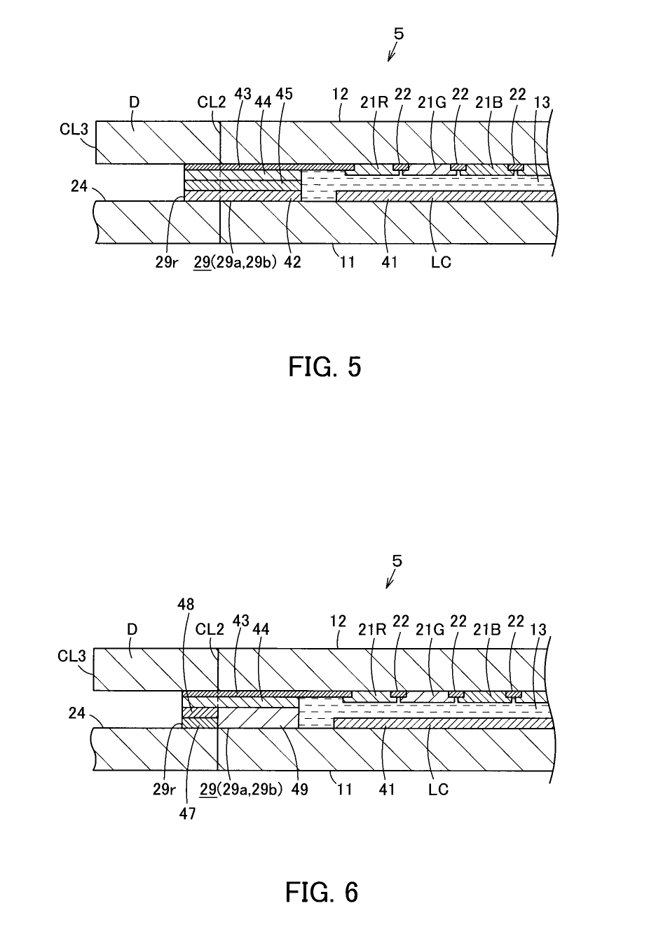

Next, a third embodiment will be described with reference to FIG. 5. Also, the same constructions and operations as those of the above-mentioned respective embodiments will be denoted with identical reference numerals, and descriptions thereof will be omitted.

In the third embodiment, the protruding portions 29a, 29b are composed of, for example, a first layer 42 formed of the same material as that of a predetermined resin layer 41 on the array substrate 11, a second layer 43 formed of the same material as that of the black matrix layer 22 on the counter substrate 12, and a third layer 44 and a fourth layer 45 formed of the same materials as those of the color filter layers 21R, 21B.

In addition, as a result of having the same construction as that of the above-mentioned first embodiment, such as sectioning the liquid crystal filling port 27 by the protruding portions 29a, 29b formed of materials different from the seal material 4, the third embodiment can provide the same operations and effects as those of the above-mentioned respective embodiments.

Next, a fourth embodiment will be described with reference to FIG. 6. Also, the same constructions and operations as those of the above-mentioned respective embodiments will be denoted with identical reference numerals, and descriptions thereof will be omitted.

For the fourth embodiment, in the above-mentioned third embodiment, formed in place of the first layer 42 and the fourth layer 45 of the protruding portions 29a, 29b are a first layer 47 serving as an adhesive blocking layer, a fourth layer 48 serving as an adhesive blocking layer, and an adhesion layer 49 to be dammed up by the first layer 47 and the fourth layer 48.

The first layer 47, which is formed of the same material as that of, for example, the resin layer 41 and in the same process as that therefor, is formed, corresponding to the position of the cut line CL2, on the circuit portion 24 of the adjacent liquid crystal cell 5 located outside the cut line CL2.

The fourth layer 48, which is formed of the same material as that of, for example, the color filter layer 21B and in the same process as that therefor, is formed, corresponding to the position of the cut line CL2, on the circuit portion 24 of the adjacent liquid crystal cell 5 located outside the cut line CL2.

In addition, the adhesion layer 49 is continuous with the adhesion layer 14, and is formed, as a result of the seal material 4 being dammed up by the first layer 47 and the fourth layer 48, at a position inside the cut line CL2 so as to be overlapped with, for example, the second layer 43 and the third layer 44.

In addition, as a result of having the same construction as that of the above-mentioned first embodiment, such as sectioning the liquid crystal filling port 27 by the protruding portions 29a, 29b formed of materials different from the seal material 4, the fourth embodiment can provide the same operations and effects as those of the above-mentioned respective embodiments.

Moreover, using a part of the seal material 4 for formation of the protruding portions 29a, 29b allows constructing more simply without decreasing the accuracy of the shape and dimensions thereof.

Furthermore, as a result of providing the first layer 47 and the fourth layer 48, the seal material 4 can be prevented from flowing into the adjacent liquid crystal cell 5, so that the tip portions of the protruding portions 29a, 29b are not adhered to the circuit portion 24 of the adjacent liquid crystal cell 5, and the tip portions of the protruding portions 29a, 29b are removed as the removing portions 29r along with the cutting margin D when cutting away the cutting margin D, and thus this allows reliably preventing, when cutting away the cutting margin D, occurrence of cracking and the like in the circuit portion 24 and the like of the adjacent liquid crystal cell 5.

Also, in the above-mentioned respective embodiments, the protruding portion 29 may be formed of any number of layers using any material of either the substrate 11 or 12.

In addition, at least any of the layers of the protruding portion 29 may be formed of a metal. In this case, the thickness can be set minutely as compared to when being formed of a resin, so that the accuracy of the protruding portion 29 can be further improved.

### INDUSTRIAL APPLICABILITY

The present invention can be applied to, for example, a display device such as a mobile phone.

1. A liquid crystal display element comprising:
a pair of substrates adhesively attached to each other by an adhesive;
a liquid crystal layer made of a liquid crystal material and interposed between the pair of substrates; and
a protruding portion provided with a material different from the adhesive on a principal surface of either one of the pair of substrates, for sectioning a liquid crystal filling port for filling the liquid crystal material between the pair of substrates.

2. The liquid crystal display element according to claim 1, wherein the protruding portion is overlapped with a part of the adhesive.

3. The liquid crystal display element according to claim 1 or 2, wherein the protruding portion is formed of a material interposed between the pair of substrates.

4. The liquid crystal display element according to claim 1 or 2, wherein the protruding portion is formed of a material interposed between the pair of substrates and being of at least either of a metal or a resin.

5. The liquid crystal display element according to claim 1 or 2, wherein the protruding portion is formed of a material containing no adhesive component.

6. A liquid crystal display element comprising:
a pair of substrates adhesively attached to each other by an adhesive;
a liquid crystal layer made of a liquid crystal material and interposed between the pair of substrates; and
a protruding portion provided with a material different from the adhesive on a principal surface of either one of the pair of substrates, for sectioning a liquid crystal filling port for filling the liquid crystal material between the pair of substrates, wherein
the one of the substrates includes a projecting part projected outward further than the other substrate, and
the protruding portion includes an adhesive blocking layer for blocking the adhesive from flowing into the projecting part, and is formed of a material containing no adhesive component.

7. A liquid crystal display element comprising:
a pair of substrates adhesively attached to each other by an adhesive;
a liquid crystal layer made of a liquid crystal material and interposed between the pair of substrates; and
a protruding portion provided with a material different from the adhesive on a principal surface of either one of the pair of substrates, for sectioning a liquid crystal filling port for filling the liquid crystal material between the pair of substrates, wherein
the one of the substrates includes a projecting part projected outward further than the other substrate, and
the protruding portion includes an adhesive blocking layer for blocking the adhesive from flowing into the projecting part, and is formed of a material containing no adhesive component being overlapped with a part of the adhesive.
